(19) United States
(12) Patent Application Publication
(10) Pub. No.: US 2022/0262283 A1
(43) Pub. Date: Aug. 18, 2022

(54) PROGRAMMABLE FILM DISPLAY SYSTEM

(71) Applicant: Hewlett-Packard Development Company, L.P., Spring, TX (US)

(72) Inventors: Christoph Graham, Spring, TX (US); James L. Mondshine, Spring, TX (US); Irwan Halim, Spring, TX (US)

(73) Assignee: Hewlett-Packard Development Company, L.P., Spring, TX (US)

(21) Appl. No.: 17/629,800

(22) PCT Filed: Sep. 30, 2019
(86) PCT No.: PCT/US2019/053760

§ 371 Date: Jan. 25, 2022

(51) Int. Cl. G09F 9/37; G06K 1/12; G09G 3/00; G09G 3/34

(52) U.S. Cl. CPC G09F 9/372; G09G 3/344; G09G 3/002; G06K 1/128

(57) ABSTRACT

In an example implementation according to aspects of the present disclosure, a system comprising a light source, a transparent programmable film, a lensing system, a memory and an embedded controller. The embedded controller may be coupled to the memory and configured to retrieve a first image from the memory. The embedded controller may be configured to render the first image on the transparent programmable film. Additionally, the embedded controller may be configured to activate a light source, wherein the light source projects light through the transparent programmable film through the lensing system, and creates a visual representation corresponding to the first image on a nearby surface.

### BACKGROUND

Products in commerce may include markings visible to a user to indicate information. Information may include regulatory compliance information, serial numbers, product numbers, patent number markings and as well as other visual information.

### BRIEF DESCRIPTION OF THE DRAWINGS

FIG. 1A illustrates a system corresponding to a programmable film disc system, according to an example;

FIG. 1B illustrates a system corresponding to a programmable film display system, according to another example;

FIG. 2 is a flow diagram illustrating a method for displaying an image with a programmable film display system, according to an example; and

FIG. 3 is a computing device for supporting programmable film display system, according to an example.

### DETAILED DESCRIPTION

Products in commerce may be required to include markings visible to a user to indicate information. The information may vary by regulator jurisdiction. Additionally, product manufacturers may choose to include identification information on the product to more readily distinguish one similar product from another. Product manufacturers may include information relating to product numbers, serial numbers, stock keeping units (SKUs) and also machine-readable codes. Machine readable codes may include universal products codes (UPC), quick response (OR) codes, as well as fiducial machine-readable marks. Historically, the identification information may be printed or etched directly onto a non-descript portion of the product (e.g. the bottom). In some other implementations, the identification information may be adhered as a sticker to a non-descript portion of the product. In both implementations, the identification information may fail in a number of ways. The sticker adhesive may fail, and the sticker may become unattached. In both the direct printing and the sticker implementations, the identification information may become unreadable by human or machine due to ink failure (e.g. fading) or scratches/removal.

Additional issues with these approaches include the necessity to change when the product moves from one regulatory jurisdiction, to another. Often, the labeling is created to be static, in that the labeling may not be meant for updating. Creating new sticker labeling may be problematic or costly, if the previous sticker labeling has already failed. Printing directly any new information onto the product may be difficult to impossible depending on the previous method of direct printing.

Products, especially electronic devices, have been trending smaller in size. The space required on the device for marking has likewise been shrinking. In some instances, the space required for marking the products in a way that is readable by human and machine, may include an entire side of the product, thereby decreasing the visual appeal of the product. As described herein, is a programmable film display system that allows for minimal surface space of a product to be consumed by markings, allows for updatability, and provides a survivability of the markings longer than other methods.

The programmable film display system may be integrated into electronic devices such as laptop computers, desktop computers, retail systems, tablets, and mobile devices to name a few. The programmable film display system may be integrated into an electronic device in a discreet manner where it does not affect the overall industrial design of the electronic device. In one implementation, the programmable film display system utilizes a transparent programmable film (e.g. electro-phoretic or e-paper display) coupled to an embedded controller and light source to project the identification information onto a nearby surface.

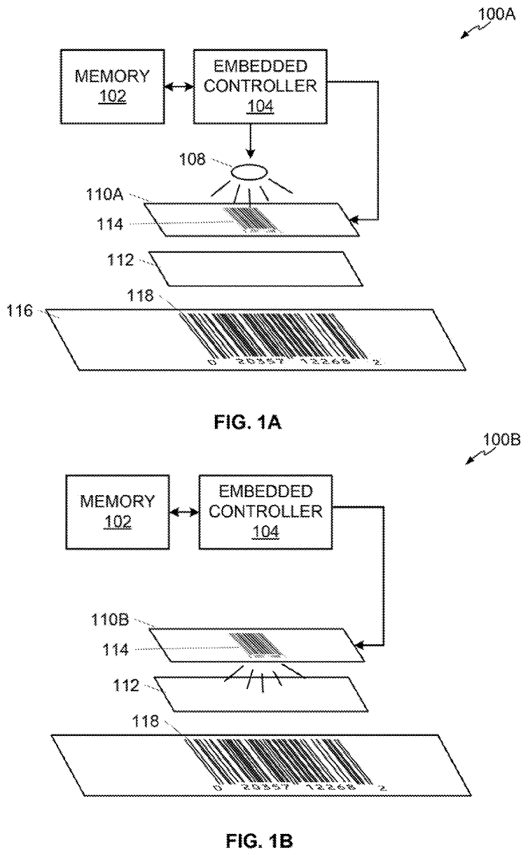

FIG. 1A illustrates a system 100A corresponding to a programmable film display system, according to an example. The system 100A may include a memory 102, an embedded controller 104, a light source 103, a programmable film 110A, and a lensing system 112.

The memory 102 may be communicatively coupled to the embedded controller 104. The memory 102 may be implemented as a non-volatile flash memory similar or the same as to the host electronic device's firmware (e.g. BIOS, UEFI). The firmware may be a machine-readable media embedded in the host electronic device for boot strapping an operating system. In another implementation, the memory 102 may be implemented as random access memory (RAM), of the host electronic device. In another implementation, the memory 102 may be implemented as system storage in an electromechanical implementation such as a hard disc drive. The memory 102 may be utilized to include instructions for the embedded controller 104 for retrieving a digital representation of an image 114. In one implementation, the memory 102 may be the non-volatile flash memory of the host electronic device and includes the machine-readable instructions for the retrieval of the image, any instructions for processing the image, instructions for displaying the image, and the digital representation of the images.

The memory 102 may be independent of the host electronic device. In this implementation, the memory 102 may be programmed or updated independently of the operational state of the host electronic device. Similarly, the memory 102 may not be modified or accessed by the host electronic device. By separating the memory 102 from the host electronic devices memory resources, any information stored in the memory 102 may be less tamper prone, and thereby enhance security.

The memory 102 may be a shared resource of the host electronic device. As mentioned previously, the memory may be a part of the host electronic device's firmware, RAM, or hard disc drive system. The shared resource implementation has the benefit of lowering the cost of implementation.

The embedded controller 104, in an implementation, may be an electronic device's firmware (e.g. BIOS, UEFI). Utilizing the host electronic device's firmware provides a cost benefit of utilizing a pre-existing component to operate the programmable film display. In another implementation, the embedded controller 104 may be a separate programmable circuitry specially designed to operate the programmable film display system. The embedded controller 104 may be a low power, low cost processor designed to interface with the host electronic device's power subsystem. The advantage of utilizing separate programmable circuitry allows the programmable film display system to operate independently of the host electronic device's operational state while not disturbing the compute resources of the host electronic device. For example, in this implementation, the host electronic device central processing unit (CPU) may remain off while the embedded controller 104 is activated and operating the programmable film display system.

The programmable film display system 100A may include a light source 108. The light source 108 may be a light emitting diode electrically coupled to and controlled by the embedded controller 104. The light source 108 may be implemented utilizing other light projecting technologies including but not limited to incandescent bulb, organic light emitting diode (OLED), and halogen bulb. The light source 108 may be configured to project light through the transparent programmable film 110.

The transparent programmable film 110A may be electrically coupled to and controlled by the embedded controller 104 in one implementation the transparent programmable film 110A may be an electro-phoretic display such as an e-paper display. In one implementation the electro-phoretic display may be a low power, low refresh transparent programmable film 110A. As the programmable film display system may be operated infrequently, the refresh performance of the display may be compromised in favor of power efficiency. The transparent programmable film 110A may be positioned between the light source 108 and the lensing system 112 so that light emitted from the light source may pass through the transparent programmable film 110A, and then through the lensing system 112.

An image 114 may be rendered on the transparent programmable film 110A. The rendering may be implemented using a technique suited for the format of the transparent programmable film 110A. The image 114 may correspond to identification information corresponding to the host electrical device. For example, the image 114 may include a UPC as shown. Additionally, the image 114 may include elements not shown in FIG. 1A, including QR codes, serial numbers, product numbers, branding, and regulatory information.

A lensing system 112 may be implemented to allow for magnification of the image 114 as rendered on the transparent programmable film 110A. The lensing system 112 may be implemented with a Fresnel lens system. The lensing system 112 may incorporate adjustments to correct for projection distortions so that the visual representation 118 of the image 114 corresponds to a scaling of the image 112.

A nearby surface 116, while not directly incorporated into the programmable film display system, provides a surface to receive the visual representation 118 of the image 114. The nearby surface 116 may be a surface suited to receive the visual representation 118. For example, a desk top may be a suitable nearby surface 116. The nearby surface 116 may also include properties for displaying the visual representation 118 better for human reading. For example, a non or less reflective finish on the nearby surface 116 may aid in human and machine reading of the visual representation 118. The nearby surface 116 may be near enough to allow for a low power light source 108 to project the image and for the visual representation 118 to be discernable by a human or machine reader.

The visual representation 118 corresponds to the image 114 as projected through the transparent programmable film 110A, through the lensing system 112 and onto a nearby surface 116. The visual representation 118 may include all of the details of the image 114 and may be readable by both human and machine. The visual representation 116 may allow the programmable film display system to occupy a small physical portion of a host electronic device yet increase the size and readability of any identification information contained in the image 114 and the visual representation 118.

FIG. 18 illustrates a system 1008 corresponding to a programmable film display system, according to another example. Referring to FIG. 1A, the common elements from both FIG. 1A and FIG. 1B correspond in form and function.

In system 1008, the transparent programmable film 110B may be implemented with an integrated light source or in another implementation, where the light source may be inherent in the transparent programmable film 110B. For example, the transparent programmable film 110E may include an arra_{y} of OLEDs, a micro OLED display or an LED display with an integrated backlight system.

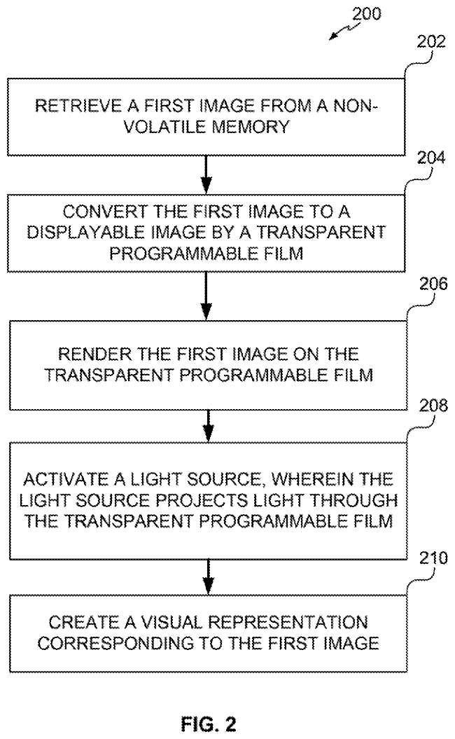

FIG. 2 is a flow diagram 200 illustrating a method for displaying an image with a programmable film display system, according to an example. The method described herein, may correspond to a user-initiated event. The user-initiated event may include activating a switch communicatively coupled to an embedded controller.

At 202, the embedded controller may retrieve a first image from a non-volatile memory. The embedded controller may be electrically and communicatively coupled to a non-volatile memory. The embedded controller may access a memory address within the non-volatile memory corresponding to the beginning address containing a digital representation of the first image.

At 204, the embedded controller may convert the first image to a displayable image by a transparent programmable film. The embedded controller may apply any corrective transforms of the digital representation of the first image to allow the first image to be displayable on the transparent programmable film. Conversions may include changing the digital representation of the first image from greyscale to black and white. In another implementation the embedded controller may convert the digital representation of the first image from color to black and white. In another implementation the embedded controller may invert the digital representation of the first image. The conversions may be utilized to better prepare the digital representation of the first image for the underlying display type of the transparent programmable film.

At 206, the embedded controller may render the first image on the transparent programmable film. The embedded controller may transfer the digital representation over a bus to the transparent programmable film. The transfer may include activating respective pixels on the transparent programmable film, such that the digital representation of the first image may be a “blacked out image” where the transparent programmable film becomes opaque and light may not traverse the transparent programmable film.

At 208, the embedded controller may activate a light source, wherein the light source projects light through the transparent programmable film through a lensing system. The light source as described previously, may be a separate light source or an integrated light source. In another implementation, the light source may be activated by the switch whereas the transparent programmable film may be controlled separately by the microcontroller.

At 210, the activated light source creates a visual representation corresponding to the first image on a nearby surface. The visual representation corresponds to the first image however the lensing system may magnify the visual representation to provide a larger viewable version of the first image.

In another implementation, responsive to second user-initiated event, the embedded controller may retrieve a second image from the memory, wherein the second image differs from the first image. The second user-initiated event may include an additional activation of the switch. Upon receiving the second user initiated event at the embedded controller, the embedded controller may advance a memory access pointer to a memory address corresponding to a second digital representation corresponding to the second image. The second image may include more identification information different than the information in the first image.

The embedded controller may create a delta from the first image to the second image. The delta may correspond to any changes from the digital representation of the first image to the second digital representation of the corresponding second image, so that only pixels on the transparent programmable film may be updated.

The embedded controller may update the first image with the delta on the transparent programmable film, wherein the updated first image corresponds to the second image. The embedded controller may use the delta to augment the digital representation of the first image on the transparent programmable film with any calculated changes of transitioning to the second digital representation of the second image.

The embedded controller may activate the light source, wherein the light source projects light through the transparent programmable film through the lensing system. The activation of the light affects the transition from the digital representation of the first image to the second digital representation corresponding to the second image. The activation of the light thereby creates a second visual representation corresponding to the second image on a nearby surface.

In another embodiment, a super-user may program the images to the programmable file display system. A super-user corresponds to a user with advanced privileges over that of a usual end user. The super-user may correspond to a system administrator, a repair technician, or a factory worker. The super-users may initiate a super-user-initiated event. The super-user-initiated event may include connecting a data transfer interface to an input/output (I/O) port of the host electronic device. The I/O port may include but isn't limited to a universal serial bus (USB) port. The I/O port may be communicatively coupled to the embedded controller. The embedded controller may receive authentication and authorization information corresponding to the super-user in a protocol exchange over the data transfer interface via the I/O port.

Upon authentication and authorization, the embedded controller may receive the first and second image from a factory programming interface. The factor programming interface may be a combination of physical interface and protocol interface unique to any super-user-initiated events initiated by the super-user. In some implementations, a firmware (application programming interface) API or an operating system (OS) API may be able to use the SMBUS (I2C) to program the first and second image at the factory.

The embedded controller writes the first and second image to the non-volatile memory and, responsive to the writing, locking the non-volatile memory as read only.

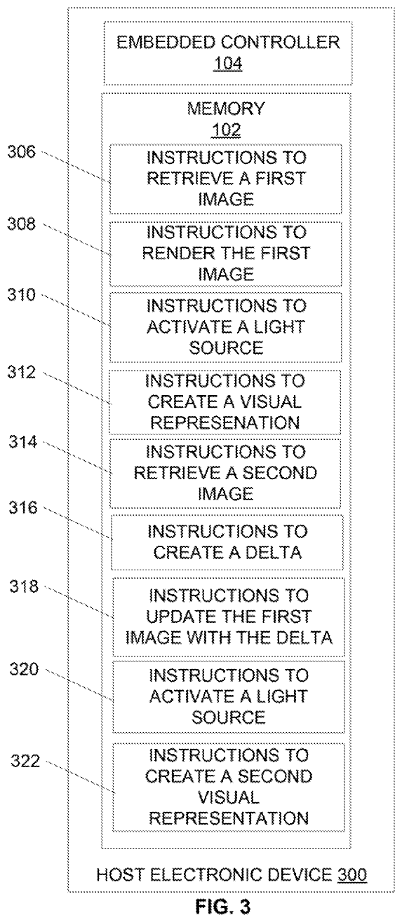

FIG. 3 is host electronic device 300 for supporting programmable film display system, according to an example. The host electronic device 300 depicts an embedded controller 104 and a memory 102 and, as an example of the host electronic device 300 supporting the programmable film display system operations, the memory 102 may include instructions 306-322 that are executable by the embedded controller 104. The embedded controller 104 may be synonymous with the embedded processors found in common computing environments not including central processing units (CPUs). In another implementation the embedded controller 104 may be an embedded microcontroller for processing inputs. The memory 102 can be said to store program instructions that, when executed by embedded controller 104, implement the components of the host electronic device 300. The executable instructions may correspond to computer implemented instructions corresponding to the method of FIG. 2. The executable program instructions stored in the memory 102 include, as an example, instructions to retrieve a first image 306, instructions to render the first image 308, instructions to activate a light source 310, instructions to create a visual representation 312, instructions to retrieve a second image 314, instructions to create a delta 316, instructions to update the first image with the delta 318, instructions to activate a light source 320, and instructions to create a second visual representation 322.

Memory 102 represents generally any number of memory components capable of storing instructions that can be executed by embedded controller 104. Memory 102 is non-transitory in the sense that it does not encompass a transitory signal but instead is made up of at least one memory component configured to store the relevant instructions. As a result, the memory 102 may be a non transitory computer-readable storage medium. Memory 102 may be implemented in a single device or distributed across devices. Likewise, embedded controller 104 represents any number of processors capable of executing instructions stored by memory 102. Embedded controller 104 may be integrated in a single device or distributed across devices. Further, memory 102 may be fully or partially integrated in the same device as embedded controller 104, or it may be separate but accessible to that device and embedded controller 104.

In one example, the program instructions 306-322 can be part of an installation package that, when installed, can be executed by embedded controller 104 to implement the components of the host electronic device 300. In this case, memory 102 may be a portable medium such as a CD, DVD, or flash drive, or a memory maintained by a server from which the installation package can be downloaded and installed. In another example, the program instructions may be part of an application or applications already installed. In another example, the memory 04 may be internal flash memory to an input device, wherein the program instructions 306-322 may be installed from the input device manufacturer. Here, memory 102 may include integrated memory such as a flash ROM, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein,

What is claimed is:

1. A system comprising:
a light source;
a transparent programmable film;
a lensing system;
a memory; and
an embedded controller, communicatively coupled to the memory to:
retrieve a first image from the memory;
render the first image on the transparent programmable film;
activate the light source, wherein the light source projects light through the transparent programmable film through the lensing system, and creates a visual representation corresponding to the first image on a nearby surface.

2. The system of claim 1 further comprising a switch, wherein the switch is communicatively coupled to the embedded controller and signals the embedded controller to:
retrieve a second image from the memory, wherein the second image differs from the first image;
update the first image on the transparent programmable film, wherein the updated first image corresponds to the second image; and
activate the light source, wherein the light source projects light through the transparent programmable film through the lensing system and creates a second visual representation corresponding to the second image on a nearby surface.

3. The system of claim 2, further comprising the embedded controller to:
receive the first and second image from a factory programming interface,
write the first and second image to the memory, and
responsive to the writing, lock the memory as read only.

4. The system of claim 1, wherein the transparent programmable film comprises an electro-phoretic (e-paper) display.

5. The system of claim 1, wherein the embedded controller corresponds to the firmware of a computing device.

6. A method comprising:
retrieving a first image from a non-volatile memory;
converting the first image to a displayable image by a transparent programmable film;
rendering the first image on the transparent programmable film;
activating a light source, wherein the light source projects light through the transparent programmable film through a lensing system; and
creating a visual representation corresponding to the first image on a nearby surface.

7. The method of claim 6 further comprising:
retrieving a second image from the memory, wherein the second image differs from the first image;
create a delta from the first image to the second image;
updating the first image with the delta on the transparent programmable film, wherein the updated first image corresponds to the second image;
activating the light source, wherein the light source projects light through the transparent programmable film through the lensing system; and
creating a second visual representation corresponding to the second image on a nearby surface.

8. The method of claim 7, further comprising:
receiving the first and second image from a factory programming interface;
writing the first and second image to the non-volatile memory; and
responsive to the writing, locking the non-volatile memory as read only.

9. The method of claim 6, wherein the transparent programmable film comprises an electro-phoretic (e-paper) display.

10. The method of claim 6, wherein the non-volatile memory comprises a device firmware.

11. A non-transitory computer readable medium comprising instructions executable by a processor to:
retrieve a first image from a non-volatile memory;
render the first image on a transparent programmable film;
activate a light source, wherein the light source projects light through the transparent programmable film through a lensing system;
create a visual representation corresponding to the first image on a nearby surface;
retrieve a second image from the nor-volatile memory, wherein the second image differs from the first image;
create a delta from the first image to the second image;
update the first image with the delta on the transparent programmable film, wherein the updated first image corresponds to the second image;
activate the light source, wherein the light source projects light through the transparent programmable film through the lensing system; and
create a second visual representation corresponding to the second image on a nearby surface.

12. The non-transitory computer readable medium of claim 11, the instructions further comprising:
receive the first and second image from a factory programming interface;
write the first and second image to the non-volatile memory; and
responsive to the writing, lock the non-volatile memory as read only.

13. The non-transitory computer readable medium of claim 11, wherein the transparent programmable film comprises an electro-phoretic (e-paper) display.

14. The non-transitory computer readable medium of claim 11, wherein the non-volatile memory comprises a device firmware.

15. The non-transitory computer readable medium of claim 11, wherein the lensing system comprises a Fresnel lens.
